(19) United States
(12) Patent Application Publication
(10) Pub. No.: US 2016/0186922 A1
(43) Pub. Date: Jun. 30, 2016

(54) MESHING TYPE ANGLE FIXING STRUCTURE

(71) Applicant: Shenzhen Wanjia Lighting Co., Ltd., Shenzhen (CN)

(72) Inventor: Fei LI, Shenzhen (CN)

(21) Appl. No.: 14/933,708

(22) Filed: Nov. 5, 2015

(30) Foreign Application Priority Data
Dec. 31, 2014 (CN) 201420872682.0

(51) Int. Cl. F16M 13/02

(52) U.S. Cl. CPC F16M 13/02; F16M 13/027; F16M 2200/024

(57) ABSTRACT

The invention relates to the technical filed of wall fixing structures and discloses a meshing type angle fixing structure used to fix a device to an external plane, which includes a fixing portion for being fixed to the external plane and a regulating portion for fixing the device, the fixing portion comprises a fixing hook of which the front end extending and bending into a hook shape, the internal side of the fixing hook is provided with a plurality of protruding teeth, the regulating portion includes a regulating end that can extend into the bending front end of the fixing hook, and second protruding teeth that can mesh with the first protruding teeth are set on the regulating end. The meshing type angle fixing structure in the present invention is fixed by means of the manner of meshing, and thus achieves firm fixing and a long service life; it can select different second protruding teeth to mesh with the first protruding teeth by rotating, thereby achieving the effect of changing the fixing angle of the device, so that the manner of regulating the angle is simpler.

### THCHNICAL FIELD

The invention relates to the technical field of wall fixing structures, particularly to a meshing type angle fixing structure.

### BACKGROUND

When equipments that need to ensure irradiation angles, such as lamps, cameras, projectors, etc., are mounted, they generally need to be mounted on a wall face or other faces by means of fixing structures with adjustable angles, and their angle can also be regulated suitably after they are mounted, thereby achieving the pre-desired mounting requirements.

These types of fixing structures in the prior art are generally fixed by a turnplate matched with a bolt, or fixed by employing a ball joint structure; the regulation of the former is a little troublesome, it needs to remove the bolt, and re-screw the bolt into the turnplate when the turnplate reaches a suitable place; the fixing of the latter isn't stable enough, especially after being used for a period of time, the wear of the spherical surface results in insufficient friction force, the angular position is difficult to be fixed, and it is prone to slide and cause failure of the device installation.

These types of angle adjustable type fixing structures applied to bar type lamps require mounting much more structures, wherein their angles cannot be regulated unless the plurality of structures are matched with each other and thus regulated and operated, and have the shortcomings of low cost-effectiveness ratio, complex combining and regulating operations, etc.

### BRIEF SUMMARY

The object of the present invention is to provide a meshing type angle fixing structure, which is used to solve the problems of fussy regulating process of the fixing structures with adjustable angles, poor fixing effects, low service lives, etc in the prior art.

The invention can be achieved in such a way that a meshing type angle fixing structure is used to fix a device to an external plane, the meshing type angle fixing structure includes a fixing portion for being fixed to the external plane and a regulating portion for fixing the device, the fixing portion comprises a fixing hook of which a front end extends and is bent into a hook shape, a plurality of protruding teeth are set on the internal side of the fixing hook, the regulating portion includes a regulating end that can extend into the bent front end of the fixing hook, a plurality of second protruding teeth that can mesh with the first protruding teeth are set on the regulating end.

Further, the first protruding teeth are set on a part of the internal side of the bent portion of the fixing hook.

Further, the regulating end is cylindrical shaped, the second protruding teeth are set along an arcuate outer side face of the regulating end circumferentially.

Further, the fixing portion includes a fixing seat for being fixed to the external plane, the fixing hook is set on the fixing seat perpendicularly, a first fixing hole through which a bolt can pass and be fixed is set on the fixing seat.

Further, the regulating portion includes a first regulating plate and a second regulating plate perpendicular to each other, an outer side face of the second regulating plate is provided with the regulating end.

Further, the regulating portion further includes a reinforcing plate for enhancing the structures of the first regulating plate and the second regulating plate, the reinforcing plate is a right-angled triangle, two square edges of which are fixed on the first regulating plate and the second regulating plate respectively.

Further, the first regulating plate is provided with a second fixing hole through which the bolt can pass.

The invention also provides another kind of meshing type angle fixing structure used to fix a device to an external plane, the meshing type angle fixing structure includes a fixing portion for being fixed to the external plane and a regulating portion for fixing the device, the fixing portion comprises a fixing plate, a meshing hole is set on the fixing plate, the internal side of the meshing hole is provided with a plurality of first protruding teeth, the regulating portion includes a regulating end that can extend into the meshing hole, the regulating end is provided with a plurality of second protruding teeth that can mesh with the first protruding teeth.

Compared with the prior art, in the meshing type angle fixing structure in the present invention, the fixing portion is fixed on the external plane, the regulating portion is fixed on the device, and the regulating portion and the fixing portion are fixed there between by the first protruding teeth and the second protruding teeth meshing with each other, and the object of changing the angle of the device can be achieved by rotating and selecting different meshing positions; this regulating manner doesn't need the aid of fixing members, its regulating operation is simple, the fixing of meshing type doesn't rely on the friction force, and it also can maintain a more stable fixing even after being wear out, thereby having a longer service life.

### BRIEF DESCRIPTION OF THE DRAWINGS

FIG. 1 is a structural schematic view of a meshing type angle fixing structure provided by an embodiment of the invention;

FIG. 2 is a meshing schematic view of the meshing type angle fixing structure provided by the embodiment of the invention.

### DETAILED DESCRIPTION OF THE PREFERRED EMBODIMENT

To make the objects, technical schemes and advantages of the present invention more apparent, the present invention will be described below in further details in combination with the following accompanying drawings and embodiments. It should be understood that the specific embodiments described herein are only used to explain the present invention and are not intended to limit the present invention.

Hereinafter, the implementation of the present embodiment will be described in detail in combination with the specific accompanying drawings.

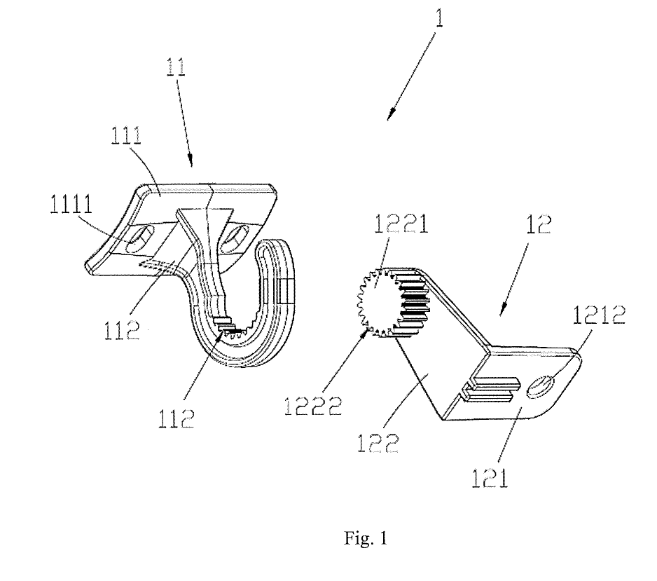

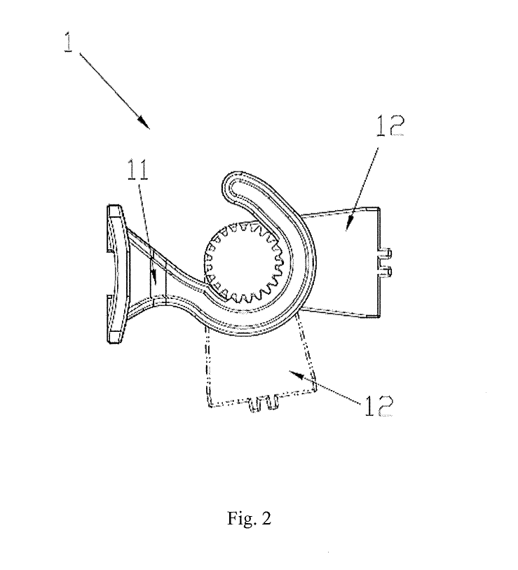

As shown in FIGS. 1 and 2, a meshing type angle fixing structure 1 in the present embodiment includes a fixing portion 11 and a regulating portion 12.

Wherein the fixing portion 11 can be fixed on an external plane and includes a fixing hook 112, a front end of the fixing hook 112 extends and is bent into a hook shape, of which an internal side is provided with a plurality of first protruding teeth 112.

The regulating portion 12 may be fixed on the device, and the regulating portion 12 comprises a regulating end 1221, the regulating end 1221 may be inserted into the bent front end of the fixing hook 112, and fit with the bent internal side face of the fixing hook 112 face to face; a plurality of second protruding teeth 1222 are set on the regulating end 1221, the second protruding teeth 1222 can be meshed with the first protruding teeth 112.

As shown in FIG. 2, when employing the meshing type angle fixing structure 1 in the present embodiment, the fixing steps of which are as follows:

1) Firstly, fixing the fixing portion 11 on an external plane, such as on a wall or a ceiling;

2) fixing the regulating portion 12 on a device that requires to be fixed;

3) adjusting the device to a desired angle, extending the regulating end 1221 of the regulating portion 12 into the fixing hook 112, and adjusting to make the second protruding teeth 1222 come into meshing with the first protruding teeth 112.

In this fixing manner, the regulating portion 12 and fixing portion 11 are meshed with each other by means of the protruding teeth therebetween, and they are fixed relying on the manner of structures abutting against each other; thus, not only the fixing effect is stable, but also the fixing stability will not be affected even after being subjected to wearing, therefore the fixing is firm. The angle adjustment is also relatively easy, it just requires selecting a required angle, placing the regulating ends 1221 into the fixing hook 112, and ensuring the mutual meshing, without the need of operations like fussy bolt removing and reloading, etc., the regulating process of which is simple and easy to operate.

Therefore, the meshing type angle fixing structure 1 in the present embodiment has the advantages of simple angle adjustment operation, good stability after being fixed, and long service life, etc.

The first protruding teeth 112 may be set on the internal side of the whole fixing hook 112, the structure set in the present embodiment is as shown in FIG. 1, the first protruding tooth 112 is only set on a part of the internal side of the bending portion of the fixing hook 112, since only the bending portion may form the partial arcuate shape in fact, after the portion has set the first protruding teeth 112, the first protruding teeth 112 can be formed in an arcuately disposed manner and mesh with the second protruding teeth 1222.

Accordingly, the regulating end 1221 is cylindrical shaped, the second protruding teeth 1222 are set along the arcuate shaped outer side face of the regulating end 1221 circumferentially, any part of which can be meshed with the first protruding teeth 112 and then fixed on the fixing hook 112, thereby providing the device with an angle adjustment range of 360°.

As shown in FIG. 1, the fixing portion 11 includes a fixing seat 111, the fixing hook 112 is set on the fixing seat 111 perpendicularly, a first fixing hole 1111 is set on the fixing seat 111, a bolt can run through the first fixing hole 1111 to fix the fixing seat 111 on the external plane.

As shown in FIG. 1, the regulating portion 12 includes a first regulating plate 121 and a second regulating plate 122 perpendicular to each other, an outer side face of the second regulating plate 122 is provided with a protruding regulating end 1221; the device is fixed on the first regulating plate 121, since the first regulating plate 121 is perpendicular to the second regulating plate 122, it can be ensured that the rotating face of the device can always be perpendicular to the external plane when the device are in the process of rotating regulation.

In order to enhance the structural stability of the first regulating plate 121 and the second regulating plate 122, the regulating portion 12 further includes a reinforcing plate (not shown), the reinforcing plate is a right-angled triangle, the two square edges of the reinforcing plate are fixed on the first regulating plate 121 and the second regulating plate 122 respectively. Due to the stability of the triangle itself, after setting the reinforcing plate, the structure of regulating portion 12 itself is more stable, so that the device can maintain the angle position stably after being fixed.

The first regulating plate 121 is provided thereon with a second fixing hole 1212, and the second fixing hole 1212 is used for the bolt to run through and fix the device.

In other embodiments, the fixing portion 11 may also be configured to include a fixing plate extending perpendicularly, the fixing plate is provided thereon with a meshing hole, a plurality of first protruding teeth 112 are set on an internal side of meshing hole. The structure of regulating portion 12 is the same as the above-described embodiment, the regulating end 1221 can be inserted into the meshing hole, so that the first protruding teeth 112 and the second protruding teeth 1222 are meshed with each other, in this way there is no need to process the hook shaped fixing hook 112, the processing cost is lower, and the effect of more stable fixing device, and simple and easy adjustment of the angle etc can be achieved.

The foregoing mentioned is only preferred embodiments of the present invention, it is not used to limit the present invention, any modifications, equivalent replacement and improvement etc made within the spirit and principles of the present invention should be included within the protection range of the present invention.

1. A meshing type angle fixing structure used to fix a device to an external plane, comprising a fixing portion for being fixed to the external plane and a regulating portion for fixing the device, wherein, the fixing portion comprises a fixing hook of which a front end is extended and bent into a hook shape, an internal side of the fixing hook is provided with a plurality of first protruding teeth, the regulating portion includes a regulating end that can extend into the bent front end of the fixing hook, the regulating end is provided with a plurality of second protruding teeth that can mesh with the first protruding teeth.

2. The meshing type angle fixing structure of claim 1, wherein the first protruding teeth are set on partial part of the internal side of the bent portion of the fixing hook.

3. The meshing type angle fixing structure of claim 1, wherein the regulating end is cylindrical shaped, the second protruding teeth are set along an arcuate outer side face of the regulating end circumferentially

4. The meshing type angle fixing structure of claim 1, wherein the fixing portion includes a fixing seat for being fixed to the external plane, the fixing hook is set on the fixing seat perpendicularly, a first fixing hole through which the bolt can pass and fix is set on the fixing seat.

5. The meshing type angle fixing structure of claim 1, wherein the regulating portion includes a first regulating plate and a second regulating plate perpendicular to each other, an outer side face of the second regulating plate is provided with the regulating end.

6. The meshing type angle fixing structure of claim 5, wherein the regulating portion further includes a reinforcing plate for enhancing the structures of the first regulating plate and the second regulating plate, the reinforcing plate is a right-angled triangle, the two square edges of the reinforcing plate are fixed on the first regulating plate and the second regulating plate respectively.

7. The meshing type angle fixing structure of claim 5, wherein the first regulating plate is provided with a second fixing hole for a bolt to pass through.

8. A meshing type angle fixing structure used to fix a device to an external plane, comprising a fixing portion for being fixed to the external plane and a regulating portion for fixing the device, wherein, the fixing portion comprises a fixing plate, the fixing plate is provided with a meshing hole, an internal side of the meshing hole is provided with a plurality of first protruding teeth, the regulating portion includes a regulating end that can extend into the meshing hole, the regulating end is provided with a plurality of second protruding teeth that can mesh with the first protruding teeth.
